(19) United States
(12) Patent Application Publication
(10) Pub. No.: US 2023/0246511 A1
(43) Pub. Date: Aug. 3, 2023

(54) ELECTRIC MOTOR

(71) Applicant: TOYOTA JIDOSHA KABUSHIKI KAISHA, Toyota-shi (JP)

(72) Inventor: Hiroyuki Ogawa, Susono-shi (JP)

(73) Assignee: TOYOTA JIDOSHA KABUSHIKI KAISHA, Toyota-shi (JP)

(21) Appl. No.: 18/085,855

(22) Filed: Dec. 21, 2022

(30) Foreign Application Priority Data
Jan. 28, 2022 (JP) 2022-012238

(51) Int. Cl. H02K 5/18; B60K 7/00

(52) U.S. Cl. CPC H02K 5/18; B60K 7/0007; B60B 27/0015

(57) ABSTRACT

An electric motor includes: a stator including stator coils; and a rotor arranged outside the stator. Further, a plurality of fins is provided at a position, which faces the stator coils, on an inner surface of the rotor.

### CROSS-REFERENCE TO RELATED APPLICATION(S)

The present application claims priority to and incorporates by reference the entire contents of Japanese Patent Application No. 2022-012238 filed in Japan on Jan. 28, 2022.

### BACKGROUND

The present disclosure relates to an electric motor.

Japanese Laid-open Patent Publication No. 2017-171252 discloses a technology of providing an air circulation vane, which generates a flow of air by rotations of a motor shaft and a rotor, in an in-wheel motor.

### SUMMARY

There is a need for providing an electric motor capable of actively creating a flow of air in the vicinity of stator coils.

According to an embodiment, an electric motor includes: a stator including stator coils; and a rotor arranged outside the stator. Further, a plurality of fins is provided at a position, which faces the stator coils, on an inner surface of the rotor.

### BRIEF DESCRIPTION OF THE DRAWINGS

FIG. 1 is a view illustrating a schematic configuration of a vehicle including an in-wheel motor according to an embodiment;

FIG. 2 is a cross-sectional view illustrating the schematic configuration of the in-wheel motor;

FIG. 3 is a perspective view of a motor rotor viewed from the inside; and

FIG. 4 is a view of the motor rotor viewed from the inside in an axial direction.

### DETAILED DESCRIPTION

In the related art, in Japanese Laid-open Patent Publication No. 2017-171252, a structure capable of actively creating a flow of air in the vicinity of stator coils that are heat generators in an in-wheel motor is not mentioned.

Hereinafter, an embodiment of an in-wheel motor that is an electric motor according to the present disclosure will be described. Note that the present disclosure is not limited by the present embodiment.

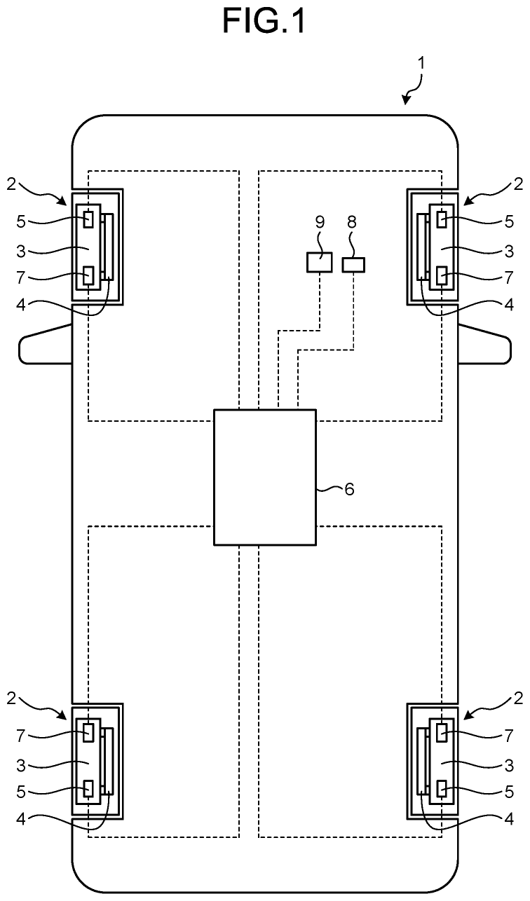

FIG. 1 is a view illustrating a schematic configuration of a vehicle 1 including an in-wheel motor 3 according to the embodiment. Note that configurations other than a configuration that causes the in-wheel motor 3 according to the embodiment to operate are omitted in FIG. 1.

In the vehicle 1 according to the embodiment, the in-wheel motor 3 is mounted as the electric motor on each of four wheels 2. A known rotating structure can be used for each of the in-wheel motors 3. For example, a disc brake 4 is arranged as a friction brake on an inner side the vehicle 1 of the in-wheel motor 3. Regarding a braking structure of the disc brake 4, the same structure as that of a related-art disc brake can be employed.

In addition, in each of the in-wheel motors 3, a motor temperature sensor 5 that detects a temperature of the in-wheel motor 3 and desirably a temperature of a stator 31 around stator coils 312 having the largest amount of heat generation (described later) is provided. A signal line from the motor temperature sensor 5 is connected to an electronic control unit (ECU) 6. The ECU 6 is configured as a microprocessor including a CPU, and includes an arithmetic unit that performs calculation by a microcomputer, a ROM that stores various processing programs, a RAM that temporarily stores data and programs and is used as a work area for data storage and program execution, an input/output port to transmit and receive various signals, and the like. In addition, signals from rotation angle sensors 7 to respectively detect the wheel speed of the wheels 2, an accelerator stroke sensor 8 to detect a pressed amount of an accelerator pedal, and a brake stroke sensor 9 to detect a pressed amount of the brake pedal are also supplied to the ECU 6.

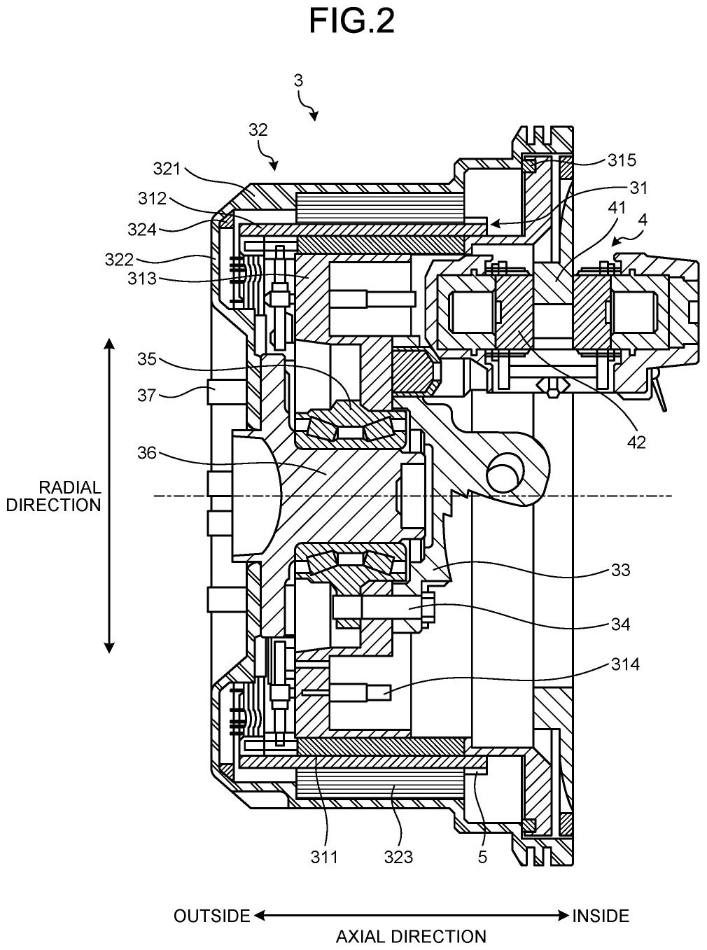

FIG. 2 is a cross-sectional view illustrating the schematic configuration of each of the in-wheel motors 3. Note that a disc rotor 41 and a caliper 42 of the disc brake 4 are also illustrated in a part of the in-wheel motor 3.

The in-wheel motor 3 includes the stator 31 and a motor rotor 32. The stator 31 includes a stator core 311, the stator coils 312, and a stator spindle 313. In addition, the stator coils 312 are arranged at equal intervals around the stator 31 having a substantially ring shape. The stator coils 312 can generate a rotating magnetic field at predetermined speed by receiving power supply from a battery at a predetermined timing according to a command from the ECU 6. By a bolt 34, the stator spindle 313 is fixed to a knuckle 33 fixed to a suspension arm. A hub bearing 35 is fixed to the knuckle 33 by the bolt 34 via the stator spindle 313, and rotatably supports a hub spindle 36. Furthermore, a cooling pin 314 to promote heat radiation from the stator 31 and to cool the stator 31 is provided in the stator spindle 313. In addition, the stator spindle 313 is provided with a sealing material 315 that seals a gap with the motor rotor 32 (rim portion 321 described later).

The motor rotor 32 having the rim portion 321 and a disc portion 322 is rotatably arranged outside the stator 31 at a predetermined interval from the stator 31. Note that in the in-wheel motor 3 according to the embodiment, the motor rotor 32 includes the rim portion 321 and the disc portion 322 as components included in a wheel portion of each of the wheels 2. The rim portion 321 is placed outside the stator 31 in a radial direction. The disc portion 322 is placed outside the stator 31 in the axial direction. A magnet 323 such as a permanent magnet is arranged on an inner peripheral side of the rim portion 321 in such a manner as to face the stator core (stator yoke) 311 of the stator 31, and the motor rotor 32 rotates with respect to the stator 31 along with movement of the rotating magnetic field. Since the motor rotor 32 is fixed to the hub spindle 36 by a hub bolt 37, the wheel 2 can be rotated at predetermined speed by the rotation of the motor rotor 32.

In addition, in the in-wheel motor 3 according to the embodiment, a space formed by the stator 31 and the motor rotor 32 in the in-wheel motor 3 is not filled with liquid such as a lubricating oil or cooling oil, and air (gas) can be exchanged inside and outside the in-wheel motor 3 (space). As a result, for example, the temperature of the stator coils 312 provided in the stator 31 can be lowered by heat radiation from the stator coils 312 to the air in the space.

Note that in the structure illustrated in FIG. 2, the motor-direct-coupled in-wheel motor 3 in which the motor rotor 32 is directly fixed to the hub spindle 36 is illustrated. However, for example, a deceleration device may be arranged between a motor rotor 32 and a hub spindle 36, and a rotation speed of the motor rotor 32 that rotates at a high speed with high efficiency may be reduced to a desired rotation speed by the deceleration device, or desired torque may be generated.

In a case of the in-wheel motor 3, it is possible to generate braking force by performing regenerative control. However, there is a case where the braking force cannot sufficiently cover that of the entire vehicle. Thus, the disc brake 4 that is the friction brake is provided in the present embodiment. In a case where the disc brake 4 is applied to the in-wheel motor 3, the disc rotor 41 of the disc brake 4 is fixed to the motor rotor 32. A known braking structure can be used for the disc brake 4. For example, as illustrated in FIG. 2, a brake pad built in the caliper 42 arranged in such a manner as to straddle a part of the disc rotor 41 is pressed against a sliding surface of the disc rotor 41 by utilization of hydraulic pressure or the like, whereby rotational braking of the disc rotor 41 can be efficiently performed. Note that in a case where braking of the vehicle 1 is performed, there is a case where the braking is performed only by regenerative braking of the in-wheel motor 3, a case where the braking is performed only by friction braking of the disc brake 4, and a case where the braking is performed by cooperative control of the both.

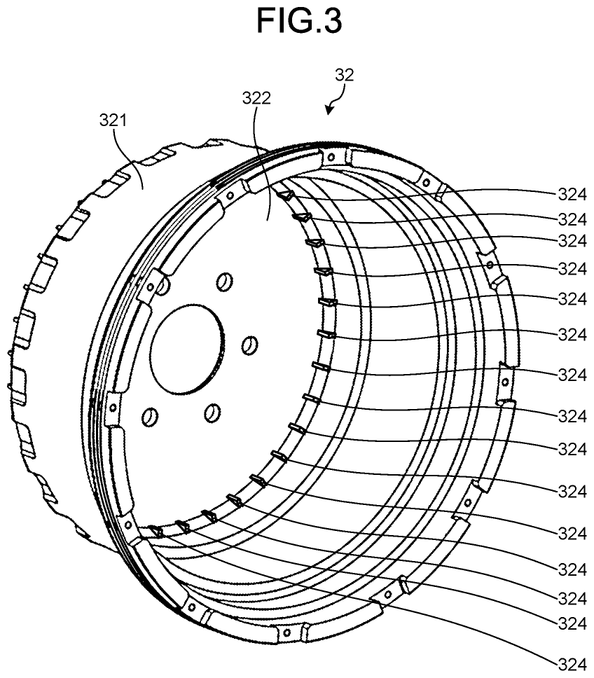

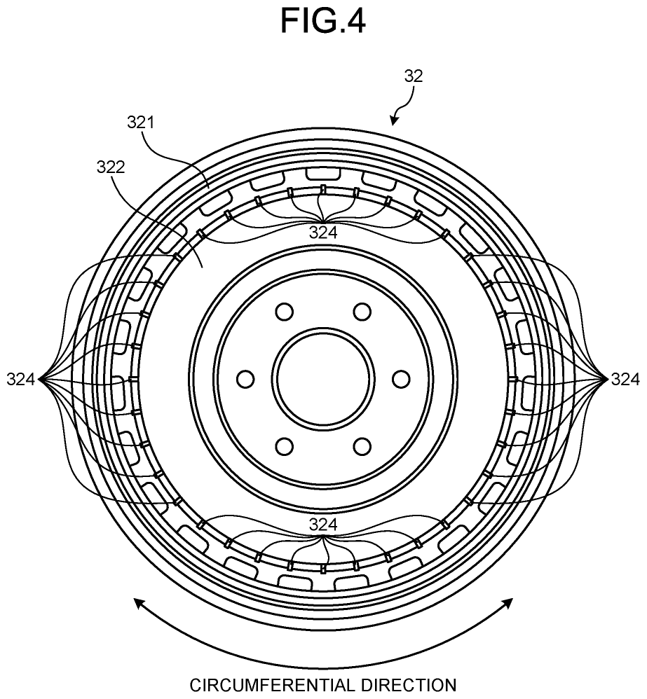

FIG. 3 is a perspective view of the motor rotor 32 viewed from the inside. FIG. 4 is a view of the motor rotor 32 viewed from the inside in the axial direction.

As illustrated in FIG. 2, FIG. 3, and FIG. 4, in the in-wheel motor 3 according to the embodiment, a plurality of fins 324 is provided at a position that faces the stator coils 312 with a gap interposed therebetween on an inner surface of the motor rotor 32 and that is in the vicinity of the stator coils 312. Specifically, the plurality of fins 324 is provided side by side in a corner portion, which is formed by the rim portion 321 and the disc portion 322 on the inner surface of the motor rotor 32, at predetermined intervals in a circumferential direction of the motor rotor 32. As a result, it is possible to effectively utilize a dead space in the motor rotor 32 and to control an increase in a size of the motor rotor 32 and eventually an increase in a size of the in-wheel motor 3.

Note that a position where the plurality of fins 324 is provided is not limited to the corner portion. For example, a plurality of fins may be provided side by side at predetermined intervals in the circumferential direction of the motor rotor 32 at a position of the rim portion 321 or the disc portion 322 on the inner surface of the motor rotor 32 which position faces the stator coils 312 with a gap interposed therebetween. As a result, the plurality of fins 324 can be provided in a manner of being closer to the stator coil 312.

In the in-wheel motor 3 according to the embodiment, since a flow of air can be actively created in the vicinity of the stator coils 312, which are heat generators that generate heat by energization, by the plurality of fins 324 along with the rotation of the motor rotor 32, the flow of air promotes an exchange of the air in the vicinity of the stator coils 312. As a result, efficiency of heat transfer from the stator coils 312 to the air increases, and an amount of heat radiation from the stator coils 312 increases. As a result, the temperature of the stator coils 312 can be lowered as compared with a case where the plurality of fins 324 is not provided.

The electric motor according to the present disclosure has an effect of being able to actively create a flow of air in the vicinity of the stator coils.

According to an embodiment, it is possible to actively create a flow of air in the vicinity of the stator coils by the plurality of fins along with a rotation of the rotor.

According to an embodiment, it is possible to effectively utilize a dead space in the rotor and to control an increase in a size of the rotor and eventually an increase in a size of the electric motor.

According to an embodiment, the plurality of fins can be provided in a manner of being closer to the stator coils.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electric motor comprising:
a stator including stator coils; and
a rotor arranged outside the stator, wherein
a plurality of fins is provided at a position, which faces the stator coils, on an inner surface of the rotor.

2. The electric motor according to claim 1, wherein the rotor includes a rim portion and a disc portion included in a wheel portion of a wheel, and
the plurality of fins is provided side by side at predetermined intervals in a circumferential direction of the rotor at a corner portion formed by the rim portion and the disc portion on the inner surface of the rotor.

3. The electric motor according to claim 1, wherein the rotor includes a rim portion and a disc portion included in a wheel portion of a wheel, and
the plurality of fins is provided side by side at predetermined intervals in a circumferential direction of the rotor at the rim portion or the disk portion on the inner surface of the rotor.
